(19) United States
(12) Patent Application Publication
(10) Pub. No.: US 2017/0057874 A1
(43) Pub. Date: Mar. 2, 2017

(54) CERAMIC OXIDE BODY, METHOD OF MANUFACTURING THEREOF, AND METHOD OF MANUFACTURING GLASS SHEET

(71) Applicant: Corning Incorporated, Corning, NY (US)

(72) Inventors: Weiguo Miao, Horseheads, NY (US); David Ivan Seymour, Corning, NY (US); Shunda Denise Cannon Wilson, Painted Post, NY (US)

(73) Assignee: Coming Incorporated, Coming, NY (US)

(21) Appl. No.: 15/119,971

(22) PCT Filed: Mar. 25, 2015
(86) PCT No.: PCT/US15/22434

§ 371 Date: Aug. 18, 2016

Related U.S. Application Data
(60) Provisional application No. 61/970,974, filed on Mar. 27, 2014.

(51) Int. Cl. C04B 35/107; C03B 17/06; C04B 35/645; C04B 35/626; C04B 35/64

(52) U.S. Cl. CPC C04B 35/107; C04B 35/62605; C04B 35/64; C04B 35/6455; C03B 17/064; C03B 17/067; C04B 2235/3217; C04B 2235/3232; C04B 2235/6027; C04B 2235/6025; C04B 2235/6022; C04B 2235/656; C04B 2235/786; C04B 2235/78; C04B 2235/9607; C04B 2235/9669

(57) ABSTRACT

A ceramic oxide body is disclosed. The ceramic oxide body may include fused cast aluminum oxide powder, fine aluminum oxide powder and titanium oxide powder.

### CROSS-REFERENCE TO RELATED APPLICATIONS

This application claims the benefit of priority of U.S. Provisional Application Ser. No. 61/970,974 filed on Mar. 27, 2014 the content of which is relied upon and incorporated herein by reference in its entirety.

### FIELD

The present disclosure relates generally to a ceramic oxide body, a method of manufacturing a ceramic oxide body, and method of manufacturing a glass sheet.

### BACKGROUND

Alumina material is used as a refractory for all kinds of applications. Alumina generally has relatively high thermal conductivity (about 40 W/m·K when measured at 20° C.). However, while thermal conductivity is an inherent property, the thermal conductivity of alumina can additionally depend from external parameters known to one having ordinary skill in the art, such as, but not limited to, porosity, grain size, and density of defects.

As an example, for dense alumina, the thermal conductivity is high, while the thermal shock performance and machinability are not good. Further, forming and machining porous alumina may be easier as long the alumina's porosity is not low enough to adversely affect the mechanical integrity of the refractory. However, the thermal conductivity of porous alumina is generally low. Thermal conductivity of alumina may additionally be affected by purity.

### SUMMARY

The following presents a simplified summary of the disclosure in order to provide a basic understanding of some example aspects described in the detailed description.

In a first aspect of the disclosure, a ceramic oxide body includes fused cast aluminum oxide powder, fine aluminum oxide powder and titanium oxide powder.

In one example of the first aspect, the fused aluminum oxide powder includes a range from about 10 wt % to about 50 wt % of the ceramic oxide body.

In another example of the first aspect, the fine aluminum oxide powder includes a range from about 10 wt % to about 50 wt % of the ceramic oxide body.

In still another example of the first aspect, the fused cast aluminum oxide powder includes a particle size distribution in a range from about 44 microns to about 700 microns.

In yet another example of the first aspect, the ceramic oxide body includes a porosity ranging from about 11.4% to about 21.3%.

In a further example of the first aspect, the ceramic oxide body includes a thermal conductivity in a range from about 10 W/m·K to about 14.5 W/m·K at 200° C.

In an additional example of the first aspect, the ceramic oxide body includes a thermal conductivity in a range from about 4 W/m·K to about 5.81 W/m·K at 1200° C.

In another example of the first aspect, a forming device includes the ceramic oxide body.

The first aspect may be provided alone or in combination with one or any combination of the examples of the first aspect discussed above.

In a second aspect, a method of manufacturing a ceramic oxide body includes the step of batching a mixture including fused cast aluminum oxide powder, fine aluminum oxide powder and titanium oxide powder, forming the mixture, and firing the formed mixture to form the ceramic oxide body.

In one example of the second aspect, the fused cast aluminum oxide powder includes a range from about 50 wt % to about 99.5 wt % of the ceramic oxide body.

In another example of the second aspect, the fine aluminum oxide powder includes a range from about 10 wt % to about 50 wt % of the ceramic oxide body.

In still another example of the second aspect, the fused cast aluminum oxide powder includes a particle size distribution in a range from about 44 microns to about 700 microns.

In yet still another example of the second aspect, the ceramic oxide body includes porosity in a range from about 11.4% to about 21.3%.

In a further example of the second aspect, the ceramic oxide body includes a thermal conductivity in a range from about 10 W/m·K to about 14.5 W/m·K at 200° C.

In another example of the second aspect, the ceramic oxide body includes a thermal conductivity in a range from between about 4 W/m·K to about 5.81 W/m·K at 1200° C.

In yet another example of the second aspect, the mixture is formed from a method selected from the group consisting of slip casting, dry pressing, cold isostatic pressing, hot pressing, hot isostatic pressing, injection molding and tape casting.

In still yet another example of the second aspect, the firing is performed between about 1550° C. and about 1650° C.

The second aspect may be provided alone or in combination with one or any combination of the examples of the second aspect discussed above.

In a third aspect, a method of manufacturing a glass sheet includes the step of forming the glass sheet using a ceramic oxide body including fused cast aluminum oxide powder, fine aluminum oxide powder and titanium oxide powder.

In one example of the third aspect, at least a portion of the ceramic oxide body receives thermal energy from a heating block.

In another example of the third aspect, the ceramic oxide body includes porosity in a range from about 11.4% to about 21.3%.

The third aspect may be provided alone or in combination with one or any combination of the examples of the third aspect discussed above.

### BRIEF DESCRIPTION OF THE DRAWINGS

These and other features, aspects and advantages of the present disclosure are better understood when the following detailed description is read with reference to the accompanying drawings, in which:

FIG. 1 is a schematic view illustrating an example of a glass forming apparatus including a forming device according to an example embodiment of the disclosure;

FIG. 2 is a cross-sectional enlarged perspective view of a forming device along line 2-2 of FIG. 1;

FIG. 3 is a cross-sectional enlarged front view of a forming device along line 2-2 of FIG. 1;

FIG. 4 is a schematic flow diagram illustrating example steps in methods of manufacturing a ceramic oxide body; and

FIG. 5 is a schematic flow diagram illustrating example steps in methods of manufacturing glass sheets.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

The terminology used herein is for describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be also understood that the term “powder” does not mean there is only one single powder. Instead, the term “powder” shall be interpreted to be a plurality of powders in an aggregated state. In this context, “powder” and “particle” are considered to denote same feature. For example, the term “particle” in particle size distribution is interpreted to be substantially identical to “powder” size distribution. The term “glass ribbon” refers to a glass being drawn from the forming device and having low viscosity enough to change the glass thickness. The term “glass sheet” refers to a glass manufactured from the forming device, having greater viscosity compared to “glass ribbon” such that the thickness of glass sheet cannot be further changed. It will be further understood that the term “fine” in “fine aluminum oxide powder” shall be interpreted with respect to the “fused cast aluminum oxide powder”, which includes overall larger powder size than fine aluminum oxide powder.

For purposes of this discussion, “COB” stands for a ceramic oxide body attained after the firing of a fully dried body at 1580° C. for 10 hours.

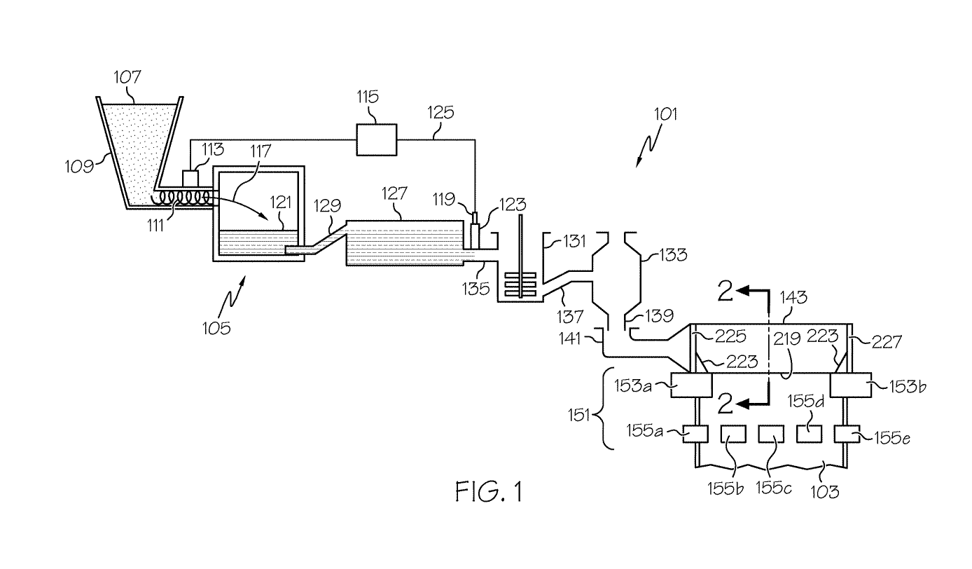

FIG. 1 illustrates a schematic view of a glass forming apparatus 101 for fusion drawing a glass ribbon 103 for subsequent processing into glass sheets. The illustrated glass forming apparatus 101 includes a fusion draw apparatus, although other fusion forming apparatuses may be provided in further examples. The glass forming apparatus 101 can include a melting vessel (or melting furnace) 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by an arrow 117. A glass metal probe 119 can be used to measure a glass melt (or molten glass) 121 level within a standpipe 123 and communicate the measured information to the controller 115 by way of a communication line 125.

The glass forming apparatus 101 can also include a fining vessel 127, such as a fining tube, located downstream from the melting vessel 105 and fluidly coupled to the melting vessel 105 by way of a first connecting tube 129. A mixing vessel 131, such as a stir chamber, can also be located downstream from the fining vessel 127. A delivery vessel 133, such as a bowl, may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver glass melt 121 from the delivery vessel 133 to an inlet 141 of a forming device 143. As shown, the melting vessel 105, fining vessel 127, mixing vessel 131, delivery vessel 133, and forming device 143 are examples of glass melt stations that may be located in series along the glass forming apparatus 101.

The melting vessel 105 can be made from a refractory material, such as refractory (e.g. ceramic) brick. The glass forming apparatus 101 may further include components that are typically made from platinum or platinum-containing metals such as platinum-rhodium, platinum-iridium and combinations thereof, but which may also comprise such refractory metals such as molybdenum, palladium, rhenium, tantalum, titanium, tungsten, ruthenium, osmium, zirconium, and alloys thereof and/or zirconium dioxide or aluminum oxide. The platinum-containing components can include one or more of the first connecting tube 129, the fining vessel 127 (e.g., finer tube), the second connecting tube 135, the standpipe 123, the mixing vessel 131 (e.g., a stir chamber), the third connecting tube 137, the delivery vessel 133 (e.g., a bowl), the downcomer 139 and the inlet 141. The forming device 143 is made from a ceramic material, such as the refractory, and is designed to form the glass ribbon 103.

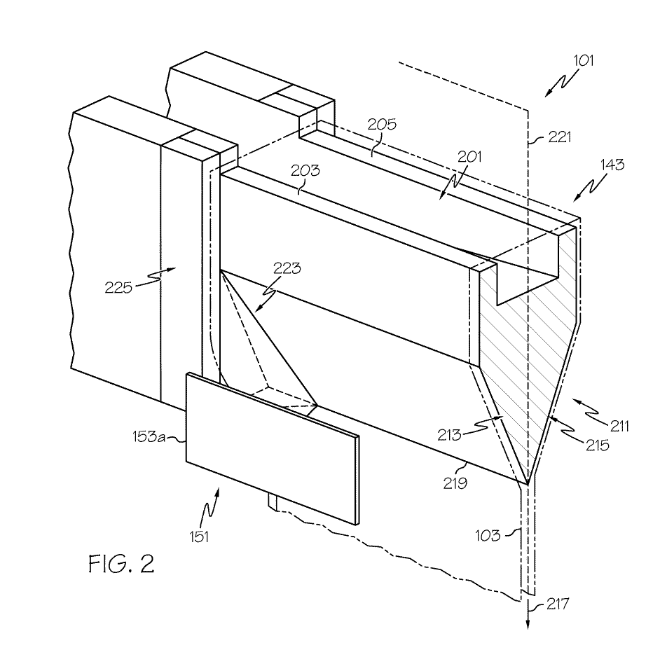

The glass forming apparatus 101 can further include one or more heating modules 151 schematically illustrated in FIGS. 1 and 2. The heating modules 151 can be located in various positions to provide heat in the form of thermal energy to a portion of the glass forming apparatus 101 to indirectly heat the glass ribbon and/or positioned to directly heat the glass ribbon. For example, the heating modules 151 may include edge director heating modules 153a, 153b configured to heat edge directors 223 (see FIG. 2) to indirectly heat edges of the glass ribbon 103 passing over the edge directors 223 and/or directly heat the edges of the glass ribbon passing over the edge directors. In such examples, edge director heating modules 153a, 153b may be independently operated to provide desired heating at each of the edge directors.

As shown in FIG. 1, in further examples, a series of heating modules 155a-e may be spaced along a heating axis to directly heat the drawn glass ribbon. In such examples, the heating modules 155a-e may be independently operated to provide a desired heat profile along the heating axis to appropriately heat a lateral extent of the glass ribbon passing by the heating axis.

In some examples, therefore, one or more heating modules 151 can be positioned near the forming device 143 for directly or indirectly projecting heat radiation to a portion of the forming device 143 and/or a glass ribbon being drawn from the forming device 143. In another instance, one or more heating modules 151 can be positioned near any glass melt stations such as melting vessel 105, fining vessel 127, mixing vessel 131, or delivery vessel 133. In yet another instance, one or more heating modules 151 can provide heat to the molten glass 121.

FIG. 2 is a cross-sectional enlarged perspective view of the forming device 143 along line 2-2 of FIG. 1. As is shown, the forming device 143 can include a trough 201 at least partially defined by a pair of weirs comprising a first weir 203 and a second weir 205 defining opposite sides of the trough 201. The forming device 143 can further include a forming wedge 211 comprising a pair of downwardly inclined forming surface portions 213, 215 extending between opposed ends of the forming wedge 211. The pair of downwardly inclined forming surface portions 213, 215 converges along a downstream direction 217 to form a root 219. A draw plane 221 extends through the root 219 wherein the glass ribbon 103 may be drawn in the downstream direction 217 along the draw plane 221. As shown, the draw plane 221 can bisect the root 219 although the draw plane 221 may extend at other orientations with respect to the root 219.

The forming device 143 may optionally be provided with one or more edge directors 223 intersecting with at least one of the pair of downwardly inclined forming surface portions 213, 215. In further examples, the one or more edge directors can intersect with both downwardly inclined forming surface portions 213, 215. In further examples, an edge director can be positioned at each of the opposed ends of the forming wedge 211 wherein an edge of the glass ribbon 103 is formed by molten glass flowing off the edge director 223. For instance, as shown in FIG. 2, the edge director 223 can be positioned at a first opposed end 225 and a second identical edge director (not shown in FIG. 2) can be positioned at a second opposed end 227 (see 223 in FIG. 1). Each edge director 223 can be configured to intersect with both of the downwardly inclined forming surface portions 213, 215. Each edge director 223 can be substantially identical to one another although the edge directors may have different characteristics in further examples. Various forming wedge and edge director configurations may be used in accordance with aspects of the present disclosure. For example, aspects of the present disclosure may be used with forming wedges and edge director configurations disclosed in U.S. Pat. No. 3,451,798, U.S. Pat. No. 3,537,834 and/or U.S. Pat. No. 7,409,839 that are each incorporated herein by reference in its entirety.

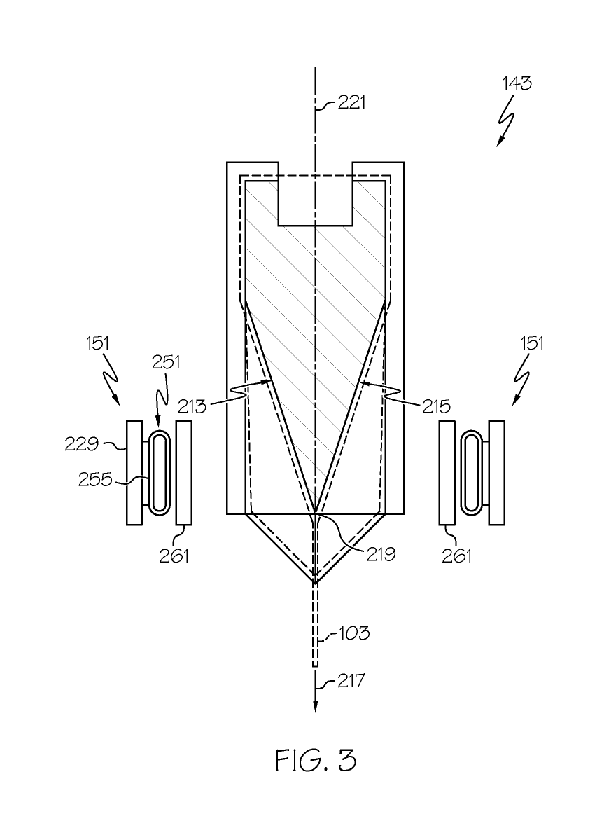

FIG. 3 illustrates an example sectional view of the forming device 143 along line 2-2 of FIG. 1, where an example location of the heating modules 151 with respect to the glass forming apparatus 101 is illustrated. As shown in FIG. 3, the heating module 151 can include at least an elongated resistive heating element 251. The resistive heating element 251 can be an elongated resistive heating element controllably bent or wound to comprise a plurality of heating segments and connecting segments. The resistive heating element 251 may include localized heating area when viewed from the glass forming apparatus 101. The resistive heating element 251 may be mounted to a mounting block 229 although the heating element 251 may be mounted to other structures or may be free standing in further examples. Alternately, a portion of the resistive heating element 251 can be partially or entirely housed, embedded, or otherwise received by the mounting block 229 or another structure. For instance, the entire resistive heating element 251 can be housed within a cavity or embedded (e.g., encapsulated) in the mounting block 229 to transfer heat through the mounting block in a direction toward a target area.

The heating modules 151 can be positioned near the target surface, for example, both sides of the forming device 143 (see FIG. 2). As illustrated, each heating module 151 can be positioned such that segments 255 of the resistive heating element 251 extend substantially parallel to the draw plane 221. In another instance, the heating module 151 can be positioned at an angle such that the segments 255 extend substantially parallel to the respective target forming surface portions 213, 215. Although not shown, in still further examples, the heating module 151 may be oriented such that the segments 255 extend at an angle with respect to the target surface depending on the heating application. However, orienting substantially parallel to the target surface can facilitate even heat distribution along the entire target-heating footprint of the heating module. The distance between the heating module 151 and the target surface can be determined based on the desired target surface temperature, the total heating power of the heating module 151, or any other method known to one having ordinary skill in the art in determining the distance between the heating module 151 and the target surface.

The forming device 143 may be provided with one or more refractory blocks 261. The refractory blocks 261 may be positioned between the forming device 143 and the resistive heating element 251 to receive thermal energy from the resistive heating element before emitting thermal energy to the target surface. The refractory blocks 261 may be in contact with the heating element 251 to partially or entirely receive at least a portion of the resistive heating element 251. Alternately, the refractory blocks 261 may be positioned with a predetermined gap from the resistive heating element 251. The refractory blocks 261 may be coupled to either the heating modules 151 or mounting block 229. Alternately, the refractory blocks 261 may be positioned independently from either the heating modules 151 or mounting block 229.

The refractory blocks 261 may be periodically exposed to high and low temperature extremes during the glass ribbon manufacturing process. In one instance, during the glass ribbon forming process, the resistive heating element 251 may be heated between about 600° C. and about 800° C. for a predetermined period in order to control the viscosity of the glass ribbon 103 flowing in the downstream direction 217. The time for operating the resistive heating element 251 can be determined based on the viscosity range required for the glass ribbon 103 flowing in the downstream direction 217 during the glass forming process.

The resistive heating element 251 may subsequently be turned off for a predetermined period, depending on the flow characteristics of the glass ribbon 103. The refractory blocks 261, which are positioned proximate to the resistive heating element 251 and heated by thermal energy from the resistive heating element 251, may also be cooled down near to room temperature. As such, by repeated cycling of the refractory blocks 261 between high and low temperatures, the refractory blocks 261 can fracture due to non-uniform dimensional changes and corresponding accumulated stress. That being said, thermal energy radiated from the resistive heating element 251 needs to pass through the refractory block with minimized thermal energy loss and minimal time lag before reaching the glass ribbon 103 or a portion of the forming device 143.

As a result, the refractory blocks 261 may be constructed to possess certain general characteristics and properties. For example, the refractory blocks 261 may be constructed to possess a certain amount of thermal shock resistance against continuous thermal cycling that occurs within a glass forming process. In addition, the refractory blocks 261 may be constructed to achieve a certain amount of thermal conductivity when being exposed to elevated temperatures. Further, the refractory blocks 261 may be constructed in order to allow thermal energy radiated from the resistive heating element 251 to pass through the refractory blocks 261 with reduced thermal energy loss and time lag before reaching the glass ribbon 103 or a portion of the forming device 143.

The refractory blocks 261 of the forming device 143 may include a plurality of COBs. The COBs may include a fused cast refractory. As an example, the fused cast refractory may be formed by heating certain refined raw materials above the melting temperature of a ceramic oxide included in the raw materials, i.e. between around 1,900° C. and 2,500° C. depending on the materials compositions, in an electric arc furnace or other high temperature furnace until the refined raw oxide materials are completely melted. However, embodiments disclosed herein are not limited thereto and can include any method of forming a fused cast refractory known to those having ordinary skill in the art. The melt of refined raw oxide materials may then be cooled into desired shapes and sizes. For example, the melt can be poured into a mold with desired shape and dimension, and left to solidify gradually to have a fused cast block with desired shape and dimension.

A COB may include fused cast aluminum oxide powder. Due to its thermal shock resistance and thermal conductivity characteristics, fused cast aluminum oxide, like other fused cast refractories, can be used for refractory applications, such as, but not limited to, the refractory blocks 261 and other uses known to those having ordinary skill in the art that are applied in glass-forming or steel-making furnaces. As an example, the fused cast aluminum oxide powder may include a range from about 50 wt % to about 99.5 wt % of the COB, but is not limited thereto. In addition, the fused cast aluminum oxide powder may include a particle size distribution in a range from about 44 microns to about 700 microns, but is not limited thereto.

While COBs described herein are described to include fused cast aluminum oxide powder, the embodiments described herein are not limited thereto. Depending on the composition of raw materials, a plurality of different fused cast refractories may be available. For example, fused cast aluminum oxide (Al₂O₃), fused cast zirconium oxide (ZrO₂), fused cast aluminum oxide-silicon oxide-zirconium oxide (Al₂O₃—SiO₂—ZrO₂) or fused cast alumina-silica (mullite, 3Al₂O₃.2SiO₂) can be used in the glass melting furnace and/or steel making furnace.

In addition to the fused cast aluminum oxide powder, the COB may additionally include fine aluminum oxide powder and titanium oxide powder, while not being limited thereto. For example, the COB may include porosity in a range from about 11.4% to about 21.3%. The porosity of the COB may serve to lessen an overall amount of time needed to machine the COB into a desired shape, as high porosity is relatively associated with loose structure. In addition, the COB may include a thermal conductivity in a range from about 10 W/m·K to about 14.5 W/m·K at 200° C. or a thermal conductivity in a range from about 4 W/m·K to about 5.81 W/m·K at 1,200° C. As such, the COB may have a thermal conductivity equal to or greater than that of 100% fused cast aluminum oxide.

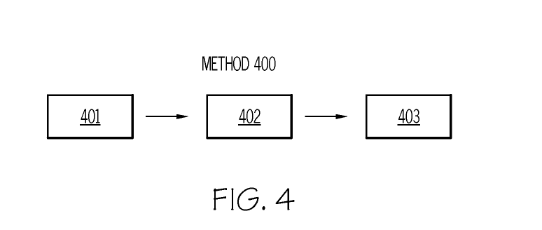

An example method for manufacturing the COB is illustrated by a flow chart pictured in FIG. 4. It may be understood that the sequence of steps depicted in FIG. 4 is for illustrative purposes only, and is not meant to limit the method in any way as it is understood that the steps may proceed in a different logical order, additional or intervening steps may be included, or described steps may be divided into multiple steps, without detracting from the disclosure.

The example method illustrated in FIG. 4 may begin at 401 by batching a mixture including fused cast aluminum oxide powder, fine aluminum oxide powder and titanium oxide powder. Fused cast aluminum powders with desired particle size distributions can be prepared by pulverizing fused cast alumina cake. The mixture may further include, but is not limited to, dispersant, binder or water, depending on the ceramic forming process selected.

At 402, the mixture may be formed. The mixture can be formed into a body with predetermined shape and dimension by at least one of a plurality of ceramic forming processes. The predetermined shape may include, but is not limited to, cube, cuboid, slab, brick, or any shape known to one having ordinary skill in the art to be used in the forming of a mixture for a manufacturing a COB.

The ceramic forming process may include, but is not limited to, slip casting, tape casting, dry pressing, cold isostatic pressing (CIP), hot pressing, hot isostatic pressing (HIP), injection molding any forming process known to one having ordinary skill in the art in which ceramic powders are packed together by external force to form the body with predetermined shape and dimension. Of these forming processes, slip casting may utilize a mold for casting the slip into a desired, and possibly complex, shape. Relatively thin COBs may be manufactured using tape casting or other similar methods known to one having ordinary skill in the art. COBs including high densities may be manufactured using CIP, HIP, or other similar methods known to one having ordinary skill in the art.

Depending on the process by which the mixture is formed, the formed mixture may be dried. For example, a mixture formed by slip casting, tape casting, or similar methods known to one having ordinary skill in the art may be dried at atmospheric temperature for about several hours to about several days.

On the other hand, a mixture that does not include water or any liquid type dispersant may not need to be dried after the forming thereof. For example, in the case of dry pressing, dispersants, binders, and water may not be added to the mixture. In another instance, binder such as poly vinyl alcohol (PVA) may be mixed with oxide powders to form the mixture into a predetermined shape by dry pressing. In yet another instance, for slip casting or tape casting, dispersant such as Tartaric acid, binder such as Scogin® HV, and/or water may be added to the mixture to provide certain rheological properties desired during slip casting or tape casting.

While PVA, Tartaric acid, and Scogin® HV are recited as dispersants and binders that can be used in the forming of the mixture, embodiments described herein are not limited thereto. For example, other dispersants and binders known to those having ordinary skill in the art can be selected in place of PVA, Tartaric acid, or Scogin® HV for forming the mixture.

At 403, the formed mixture may be fired to form the COB. After the mixture is formed, the formed mixture can subsequently be fired at a predetermined temperature for a predetermined period to form the COB. The peak firing temperature can be selected based on the composition of the formed mixture. In one instance, the formed mixture including fused cast aluminum oxide powder, fine aluminum oxide powder and titanium oxide powder may be fired at the peak temperature of between about 1500° C. and about 1680° C. for about 10 hours to form the COB. In another example, the firing may be performed between about 1550° C. and about 1650° C.

After the COB is formed by firing the formed mixture, physical properties of the COB can be measured. Physical properties can include porosity, median pore size, bulk density and thermal conductivity. Porosity and median pore size of the COB can be measured by mercury porosimeter. For determining bulk density of the COB, height, width and depth of the COB can be measured to determine the volume of the COB. Weight of the COB can be measured, thus enabling the determination of the bulk density of the COB. Thermal conductivity can be measured by laser flash method, which is based on the measurement of the temperature rise at the rear face of the thin-disc sample produced by a short energy pulse provided on the front face of the sample. Thermal conductivity can be determined based on the thermal diffusivity, specific heat and density of the specimen. In an example, thermal conductivity can be determined at two different temperatures, 200° C. and 1200° C., to analyze the temperature dependence of thermal conductivity.

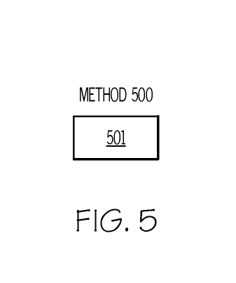

FIG. 5 is a schematic flow diagram illustrating example steps in methods of manufacturing glass sheets. Similar to FIG. 4, it may be understood that the step depicted in FIG. 5 is for illustrative purposes only, and is not meant to limit the method in any way, as it is understood that additional or intervening steps may be included, or described step may be divided into multiple steps, without detracting from the disclosure.

The method of FIG. 5 may include 501 of forming the glass sheet using the COB including fused cast aluminum oxide powder, fine aluminum oxide powder and titanium oxide powder. As discussed above, during the manufacturing of the glass sheet, it may be generally desired for the viscosity of glass melt and/or glass ribbon to be controlled as the viscosity of glass melt and/or glass ribbon is directly related with the thickness of glass ribbon and/or glass sheet. Typically, glass ribbon with high viscosity leads to thicker glass ribbon, while low viscosity of glass ribbon may result in the thinner glass ribbon.

As set forth above in discussing FIGS. 2 and 3, the viscosity and thickness of the glass ribbon can be controlled by either indirectly heating a portion of the glass forming apparatus 101 or directly heating the glass ribbon flowing off the forming device 143.

The refractory blocks 261 including a plurality of COBs can be positioned such that at least a portion of the COBs of the refractory blocks 261 receives thermal energy from the resistive heating element 251. Thermal energy received from the heating module 151 can be re-emitted from the surface of the refractory blocks 261 toward at least a portion of the glass forming apparatus 101 or glass ribbon 103, depending on the location of the refractory blocks 261 with respect to the forming device 143 or glass ribbon 103. The ceramic oxide bodies of the refractory blocks 261 may have high thermal conductivity to reduce the thermal energy loss during the thermal path from the surface of the resistive heating element 251 to the glass forming apparatus 101 or glass ribbon 103.

It is understood that thermal energy directly radiated from the resistive heating elements 251 would not be uniformly provided to the glass forming apparatus 101 or glass ribbon 103 due to localized heating area of the resistive heating elements 251. However, the COBs of the refractive blocks 261 may have a thermal conductivity that enables the provision of a uniform heating area such that achieve uniform heating of the glass forming apparatus 101 or glass ribbon 103 might take place. The thermal conductivity of the COBs of the refractive blocks 261 might further enable reduction of a local temperature gradient across the glass forming apparatus 101 or glass ribbon 103.

### EXAMPLE

For purposes of this discussion, it is understood that relatively small-sized ceramic powder can fill the space formed by relatively large-sized ceramic powder to increase the density of the formed mixture, and, correspondingly, the density of the COB after firing. On the contrary, a ceramic powder with more than one particle size distribution may be used to achieve a desired density.

Further, fine aluminum oxide powder may act as a sintering aid, by itself or in combination of one or more other oxide powders, during firing at elevated temperatures such that a COB may be formed having a desired mechanical integrity and a desired controlled porosity.

In addition, titanium oxide powder may act, alone or in conjunction with other oxide powders such as fine aluminum oxide powders, as a sintering aid for fused cast aluminum oxide powder during firing. As an example, depending on the purity and composition of oxide powders, a liquid phase may be formed at elevated temperatures, such as, but not limited, temperatures equal to or greater than about 1500° C. A liquid phase including at least one of aluminum oxide and titanium oxide may diffuse across boundaries of powders to fuse multiple powders into one body.

Moreover, the viscosity of each slip may depend on the relative ratio among the solid oxide powders, binder, dispersant and water. Generally, when the relative amount of solid oxide powders is high, the viscosity of the slip after ball milling may be high.

In this example, ten COBs were prepared from fused cast aluminum oxide powder, fine aluminum oxide powder, titanium oxide powder, binder, dispersant and water by the slip casting process. For fused cast aluminum oxide powder, three fused cast aluminum oxide powders with different particle size distributions were used. For having fused cast aluminum oxide powders with different particle size distribution, fused cast aluminum oxide cake was pulverized into powders. In this example, 28 mesh fused cast aluminum oxide powder (maximum particle size of about 700 μm), 60 mesh fused cast aluminum oxide powders (maximum particle size of about 250 μm) and 325 mesh fused cast aluminum oxide powder with size (maximum particle size of about 44 μm) were weighed as calculated in Table 1.

TABLE 1
Slip Compositions for Porous Alumina
with High Thermal Conductivity

| | Sample ID | | | | |
|---|---|---|---|---|---|
| | Slip A | Slip B | Slip C | Slip D | Slip E |
| | (wt. %) | (wt. %) | (wt. %) | (wt. %) | (wt. %) |
| Fused cast aluminum | 19 | 19 | 19 | — | — |
| oxide powder 28 | | | | | |
| Fused cast aluminum | 5 | 5 | 5 | — | — |
| oxide powder 60 | | | | | |
| Fused cast aluminum | 75.4 | 50.4 | 37.7 | 99.4 | 74.4 |
| oxide powder 325 | | | | | |
| Fine aluminum oxide | — | 12.5 | 18.9 | — | 12.5 |
| 325 | | | | | |
| Fine aluminum oxide | — | 12.5 | 18.9 | — | 12.5 |
| 3000 | | | | | |
| Titanium oxide | 0.6 | 0.6 | 0.6 | 0.6 | 0.6 |
| Scogin HV | 0.008 | 0.008 | 0.008 | 0.008 | 0.008 |
| Tartaric Acid | 0.054 | 0.054 | 0.054 | 0.054 | 0.054 |
| Water | 13.2 | 11.8 | 11.6 | 14.0 | 15.6 |
| | Sample ID | | | | |
| | Slip F | Slip G | Slip H | Slip I | Slip J |
| | (wt. %) | (wt. %) | (wt. %) | (wt. %) | (wt. %) |
| Fused cast aluminum | — | 19 | 19 | 24 | 24 |
| oxide powder 28 | | | | | |
| Fused cast aluminum | — | 5 | 5 | — | — |
| oxide powder 60 | | | | | |
| Fused cast aluminum | 49.4 | 62.9 | 50.4 | 62.9 | 50.4 |
| oxide powder 325 | | | | | |
| Fine aluminum oxide | 25 | — | — | — | — |
| 325 | | | | | |
| Fine aluminum oxide | 25 | 12.5 | 25 | 12.5 | 12.5 |
| 3000 | | | | | |
| Titanium oxide | 0.6 | 0.6 | 0.6 | 0.6 | 0.6 |
| Scogin HV | 0.008 | 0.008 | 0.008 | 0.008 | 0.008 |
| Tartaric Acid | 0.054 | 0.054 | 0.054 | 0.054 | 0.054 |
| Water | 12.8 | 13.4 | 10 | 13.3 | 10 |

The relative amounts of materials used for each slip are shown in Table 1. The relative amounts of binder, dispersant and water in each slip were represented based on the amount of all oxide powders, i.e. fused cast aluminum oxide powder 28, fused cast aluminum oxide powder 60, fused cast aluminum oxide powder 325, fine aluminum oxide 325, fine aluminum oxide 3000 and titanium oxide, such that the total amounts of materials of each slip were adjusted to 100 wt %. Fused cast aluminum oxide powders with different particle size distributions were used to control the density of the COBs. The fused cast aluminum oxide powder included, in all slip compositions in Table 1, a range from about 50 wt % (for Slip F) to about 99.5 wt % (for Slips A and D) of all oxide powders including fused cast aluminum oxide powder, fine aluminum oxide powder and titanium oxide powder.

Predetermined amounts of fine aluminum oxide powder were added to the fused cast aluminum oxide powder. Two different fine aluminum oxide powders with different particle size distributions were used—fine aluminum oxide 325 with a 325 mesh size (maximum particle size of about 44 μm) and fine aluminum oxide 3000 with an average particle size of 1 μm. At least one of two different fine aluminum oxide powders was used in mixing with the fused cast aluminum oxide powder.

The size of fine aluminum oxide powder was generally less than that of the cast fused aluminum oxide powder. As previously noted and as was the case in this example, smaller fine aluminum oxide powders filled up the space formed between fused cast aluminum oxide powders in the slip to maintain the density of the mixture during the slip casting. During slip casting, in an attempt to inhibit distortion or breakage, the mixture was formed on the gypsum mold by maintaining the density to be greater than a threshold number.

For some slips (Slips A and D), fine aluminum oxide was not included, while Slips G, H, I and J included only one type of fine aluminum oxide powder—fine aluminum oxide 3000. For Slips B, C, E and F, two different types of fine aluminum oxide powder, i.e. fine aluminum oxide 325 and fine aluminum oxide 3000, were added to the fused cast aluminum oxide powder. In the slips containing fine aluminum oxide, at least 5 wt % of the corresponding oxide powders was composed of fine aluminum oxide powder. In one example, the amount of the fine aluminum oxide powder ranged from about 10 wt % to about 50 wt % of all oxide powders including fused cast aluminum oxide powder, fine aluminum oxide powder and titanium oxide powder. As an example, as set forth in Table 1, the amount of the fine aluminum oxide powder ranged from about 12.5 wt % to about 50 wt % for the slip casting process.

A predetermined amount of titanium oxide powder with an average particle size of 1 μm was also added to form the mixture. While the slips included in this example include an amount of titanium oxide powder equal to about 0.6 wt %, the embodiments herein are not limited thereto. For example, a titanium oxide powder included in the slips could range from 0.1 wt % to about 10 wt % of the COB. The titanium oxide powder included in the slips could alternatively range from 0.1 wt % to about 5 wt % of the COB.

Each material was weighed and subsequently provided in the ball-milling machine for homogeneous mixing. Predetermined amounts of high purity alumina balls were also placed in the ball-milling machine for homogeneously mixing materials. The ball milling time ranged from about several hours to about several days.

After ball milling of the materials, the materials were in the form of viscous slips. The slips were then poured into gypsum molds with a desired shape and a geometrical size. It is noted that, although gypsum molds were used in this example, plaster molds or any other mold known by one having ordinary skill in the art to be applicable may be used.

The slips stayed in the gypsum molds for a predetermined period to form wet solid bodies in the inner wall of the gypsum molds. Subsequently, excessive slip was restored by pouring the slips in the gypsum molds to the exterior of the gypsum molds. The wet solid layer formed in the inner wall of the gypsum molds stayed in the gypsum molds for about several hours until the wet solid bodies were at least partially dried to form partially dried solid bodies. Subsequently, the partially dried solid bodies were separated from the gypsum molds and dried in the atmosphere for about more than 24 hours to form fully dried solid bodies.

The fully dried solid bodies were placed into a high temperature furnace for firing according to the firing schedule shown in Table 2 to substantially burn out and remove all volatile materials, such as binder, dispersant and water, from the fully dried solid bodies, resulting in a COBs including fused cast aluminum oxide powder, fine aluminum oxide powder and titanium oxide powder.

TABLE 2
Firing Schedule

| | Start | End | | |
|---|---|---|---|---|
| Step | Temperature | Temperature | Ramp Rate | Soak Time |
| No. | (° C.) | (° C.) | (° C./min.) | (hour) |
| 1 | Room | 200 | 25 | — |
| | Temperature | | | |
| 2 | 200 | 1,580 | 50 | — |
| 3 | 1,580 | 1,580 | — | 10 |
| 4 | 1,580 | 1,200 | 50 | — |
| 5 | 1,200 | Room | Uncontrolled | — |
| | | Temperature | | |

It is noted that firing may be accomplished or performed using any applicable method known to one having ordinary skill in the art and is not limited to the firing schedule provided above in Table 2. Moreover, it is further noted that the firing schedule provided above in Table 2 may vary in accordance with the knowledge of one of ordinary skill in the art. For example, the peak temperature at Step No. 3 can be controlled to be less than about 1,700° C., which is lower than the melting temperature of aluminum oxide (about 2,072° C.) and titanium oxide (about 1,843° C.). In addition, the peak temperature at step No. 3 of Table 2 can vary between about 1,500° C. and about 1,680° C. The ramp rate at Step No. 2 and Step No. 4 may also vary between about 20° C./min. and about 70° C./min.

After the fully dried bodies were fired to form the COBs according to the firing schedule, physical properties of the COBs were measured. The properties of the selected COBs are summarized in Table 3. In addition, “COB E” in Table 3 relates to the COB manufactured from Slip E in Table 1, and so forth.

TABLE 3
Properties of COBs

| | | | | Thermal | Thermal |
|---|---|---|---|---|---|
| | | Median | Bulk | Conductivity | Conductivity |
| Sample | Porosity | Pore Size | Density | (W/m · K) | (W/m · K) |
| ID | (%) | (μm) | (g/ml³) | at 200° C. | at 1,200° C. |
| Reference | 16.7 | 6.30 | 3.30 | 9.98 | 4.03 |
| COB B | 15.8 | 3.48 | 3.30 | 12.61 | 4.70 |
| COB C | 13.4 | 2.88 | 3.41 | 13.31 | 4.89 |
| COB E | 16.6 | 2.73 | 3.29 | 11.55 | 4.56 |
| COB F | 11.4 | 1.44 | 3.26 | 14.43 | 5.81 |
| COB G | 21.3 | 3.91 | 3.09 | 10.73 | 3.90 |
| COB H | 14.5 | 3.17 | 3.37 | 13.03 | 4.38 |
| COB I | 21.3 | 3.30 | 3.10 | 12.71 | 4.78 |
| COB J | 15.9 | 3.18 | 3.34 | 13.25 | 5.05 |

A commercial grade 100% fused cast aluminum oxide body, known by one having ordinary skill in the art to be commonly used in refractory block, was used as a Reference in Table 3 to compare the physical properties thereof with the physical properties of the COBs from the selected slips.

The porosity for the Reference was determined to be about 16.7%. A plurality of COBs manufactured from selected slips included porosity values ranging from 11.4% to about 21.3%. As an example, for the COBs manufactured from Slips G and I, a porosity of 21.3% was achieved. In addition, a plurality of parameters appeared to contribute to the porosity of the COBs, while, at least, the relative amount of fine aluminum oxide powder appeared to impact the porosity of the COBs. In one example, the COBs C, F, H and J, having greater amounts of fine aluminum oxide powder than the COBs G and I, showed relatively low porosities, 13.4%, 11.4%, 14.5%, and 15.9%, respectively. Changing the relative amounts between fine aluminum oxide powders, i.e. 325 and 3000, in the Slips B and H, resulted in differing porosities—15.8% for the COB B and 14.5% for the COB H. Of the COBs measured for porosity, the COBs E, G, and I included porosities equal to or greater than the porosity of the Reference.

With respect to thermal conductivity, almost all of the COBs (B, C, E, F, H, I and J) selected for thermal conductivity measurements showed thermal conductivities comparable to or greater than the thermal conductivity of the Reference. Only COB G showed a thermal conductivity that was less than the thermal conductivity of the Reference when measured at 1200° C. As such, it was inferred that the COBs formed by slip casting and having thermal conductivities comparable to or greater than the thermal conductivity of the Reference radiated thermal energy with reduced thermal energy loss compared with the thermal energy loss of the Reference. Overall performance of the COB I was equivalent to the 100% fused cast aluminum oxide refractory used as the Reference. In general, the manufacturing cost of the COBs was less than the manufacturing cost of the Reference.

While the COB disclosed herein is generally based on COBs including fused cast aluminum oxide powder, fine aluminum oxide powder and titanium oxide powder, embodiments described herein are not limited thereto, as it is possible that a COB may include other ceramic oxide materials known to one having ordinary skill in the art. For example, a COB may include fused cast zirconium oxide (ZrO₂) powder and fine zirconium oxide powder. Further, at least one of ceramic oxides including, but not limited to, aluminum oxide, cupric oxide or manganese oxide may be added to the fused cast zirconium oxide powder and fine zirconium oxide powder as sintering aids. In addition, a COB can include fused cast mullite powder and fine mullite powder. In yet another instance, a COB can include fused cast aluminum oxide-silicon oxide-zirconium oxide powder (Al₂O₃—SiO₂—ZrO₂) and one of fine aluminum oxide, silicon oxide and zirconium oxide.

The ceramic oxides with the above compositions can be batched to form a mixture, and then fired to form a COB. At least one ceramic oxide can be further added to the batch to work as a sintering aid during a firing step at an elevated temperature.

Various modifications and variations can be made to the embodiments described herein without departing from the spirit and scope of the claimed subject matter. Thus, it is intended that the specification cover the modifications and variations of the embodiments described herein provided such modifications and variations come within the scope of the appended claims and their equivalents. It will be apparent to those skilled in the art that various modifications and variations can be made without departing from the spirit and scope of the claims.

What is claimed is:

1. A ceramic oxide body, comprising fused cast aluminum oxide powder, fine aluminum oxide powder and titanium oxide powder.

2. The body of claim 1, wherein the fused cast aluminum oxide powder comprises a range from about 50 wt % to about 99.5 wt % of the ceramic oxide body.

3. The body of claim 2, wherein the fine aluminum oxide powder comprises a range from about 10 wt % to about 50 wt % of the ceramic oxide body.

4. The body of claim 1, wherein the fused cast aluminum oxide powder comprises a particle size distribution in a range from about 44 microns to about 700 microns.

5. The body of claim 1, wherein the ceramic oxide body comprises porosity in a range from about 11.4% to about 21.3%.

6. The body of claim 1, wherein the ceramic oxide body comprises a thermal conductivity in a range from about 10 W/m·K to about 14.5 W/m·K at 200° C.

7. The body of claim 1, wherein the ceramic oxide body comprises a thermal conductivity in a range from about 4 W/m·K to about 5.81 W/m·K at 1,200° C.

8. A forming device, comprising the ceramic oxide body of claim 1.

9. A method of manufacturing a ceramic oxide body, the method comprising the steps of:
(I) batching a mixture comprising fused cast aluminum oxide powder, fine aluminum oxide powder and titanium oxide powder;
(II) forming the mixture; and
(III) firing the formed mixture to form the ceramic oxide body.

10. The method of claim 9, wherein the fused cast aluminum oxide powder comprises a range from about 50 wt % to about 99.5 wt % of the ceramic oxide body.

11. The method of claim 9, wherein the fine aluminum oxide powder comprises a range from about 10 wt % to about 50 wt % of the ceramic oxide body.

12. The method of claim 9, wherein the fused cast aluminum oxide powder comprises a particle size distribution in a range from about 44 microns to about 700 microns.

13. The method of claim 9, wherein the ceramic oxide body comprises porosity in a range from about 11.4% to about 21.3%.

14. The method of claim 9, wherein the ceramic oxide body comprises a thermal conductivity in a range from about 10 W/m·K to about 14.5 W/m·K at 200° C.

15. The method of claim 9, wherein the ceramic oxide body comprises a thermal conductivity in a range from between about 4 W/m·K to about 5.81 W/m·K at 1200° C.

16. The method of claim 9, wherein the mixture is formed from a method selected from the group consisting of slip casting, dry pressing, cold isostatic pressing, hot pressing, hot isostatic pressing, injection molding and tape casting.

17. The method of claim 9, wherein the firing is performed between about 1550° C. and about 1650° C.

18. A method of manufacturing a glass sheet, the method comprising forming the glass sheet using a ceramic oxide body comprising fused cast aluminum oxide powder, fine aluminum oxide powder and titanium oxide powder.

19. The method of claim 18, wherein at least a portion of the ceramic oxide body receives thermal energy from a heating block.

20. The method of claim 18, wherein the ceramic oxide body comprises porosity in a range from about 11.4% to about 21.3%.
